(19) United States
(12) Patent Application Publication
(10) Pub. No.: US 2008/0015876 A1
(43) Pub. Date: Jan. 17, 2008

(54) Simulation technique for generation of AVM and collateral risk indicator rule set

(75) Inventors: Beth A. Harasimowicz, Minneapolis, MN (US); Susan Harper Allen, Eagan, MN (US)

Correspondence Address: BECK AND TYSVER P.L.L.C., 2900 THOMAS AVENUE SOUTH, SUITE 100, MINNEAPOLIS, MN, 55416, US

(73) Assignee: Residential Funding Corporation

(21) Appl. No.: 11/484,262

(22) Filed: Jul. 11, 2006

(51) Int. Cl. G06Q 10/00; G06Q 30/00

(52) U.S. Cl. 705/1

(57) ABSTRACT

An automated system is presented to create sequence of rules for submission of loan data to automated valuation models (or AV Ms) and collateral risk indicators (CRIs.) The present invention combines CRI analysis with a program to simulate, within specific geographical locations and at multiple price tiers, possible combinations of three factors: AVM order, confidence score limit, and AVM-to-estimated value ratio. Data are run through each combination to find those combinations that product an acceptable hit rate and accuracy while meeting the risk requirements of the lender. This results in a rule set that includes sequence rules that contain the proper sequence for AVM and CRI requests for that property and qualification rules that define confidence score cutoffs and acceptable AVM-to-estimated value ratios.

### FIELD OF THE INVENTION

This invention relates to the field of loan application processing. More particularly, the present invention relates to the utilization of an automated system to improve the efficiency of analyzing the value of real property through the used of automated valuation models and collateral risk indicators.

### BACKGROUND OF THE INVENTION

The mortgage industry has, since its inception, relied primarily upon home appraisals to provide an independent perspective of the value of the home securing a mortgage loan. In the past 10 years, advances in the collection of data on property characteristics and sale prices have enabled the growth of statistical models that can estimate the probable sale price of a home. These models are collectively known in the industry as Automated Valuation Models (AVMs.) An AVM includes an estimate of value for a property, along with a “confidence score” representing the AVM provider's estimate of the accuracy of its system. For example, an AVM may provide a value for the property located at 123 Main Street of $300,000 with a confidence score of 99, indicating that the model is expected to produce a high degree of accuracy for this property. Advances in the collection of property data have also enabled the creation of Collateral Risk Indicators (CRIs.) CRIs indicate the risk of overvaluation of the underlying property. A CRI contains only a score that was calculated based on the vendor's proprietary model and database. For example, a CRI may provide a score for 123 Main Street of 60, or “low risk.” AVMs have achieved acceptance by the mortgage industry as an alternative to a home appraisal for obtaining an independent home value estimate. Three Ratings Agencies (including Standard & Poors,) Freddie Mac, Fannie Mae, Citibank, Wells Fargo, Bank of America and many others encourage the use of AVMs instead of appraisals for certain mortgage lending transactions. CRIs have achieved acceptance by the mortgage industry as an indispensable tool for detecting property overvaluation, regardless of the valuation source. All of the top ten largest financial institutions use some form of CRI during their loan origination process. For darity, the remainder of this application will use the term “Model” to represent both AVMs and CRIs.

Model accuracy is dependent on large amounts of consistent and available data. For example, in neighborhoods with similar homes, a robust real estate market, and a county recorder's office that keeps detailed data, Models can produce very accurate results. In rural areas where properties are dissimilar and rarely sold, or in counties that do not disclose property data, Models will produce less accurate results. One AVM may choose not to produce a result on such a property, while another may produce a result with a low confidence score. Each Model provider maintains a database comprised of public and proprietary data.

While it is possible for a lender to use a single Model for all of its property valuations, this is not the preferred practice since there is no one Model that is effective at evaluating every property. This is because each Model provider has a unique database and a unique modeling approach. Every Model has certain properties in which it will be unable to provide a result. A Model's “hit rate,” meaning the percentage of property valuation requests that are able to be fulfilled with a property value, and accuracy can vary from one geographic location to another throughout the country or even within a city. In addition, it is common knowledge that for every type of property (such as condominium or single family home), some Models are able to deliver more accurate results than others. It is possible to test the performance of individual Models to discover where each Model tends to have “sweet spots” where it can perform very well. Because of these differing sweet spots, using multiple Models will almost always result in greater accuracy in determining a property's real value.

### SUMMARY OF THE INVENTION

In order to implement usage of Models within a business, it is necessary to obtain Model results on test data, and compare results to known outcomes. The test data are then examined to assess Model performance, and to determine a rule set to be used to govern Model usage. To improve rule set generation, the present invention first analyzes multiple CRIs to determine the suitability of AVMs as a valuation source, and second uses a program to simulate, within various geographic areas at multiple price tiers, possible combination of three factors: AVM order, confidence score limit, and AVM-to-estimated value ratio. Data are run through each combination to find those combinations that produce an acceptable hit rate and accuracy while meeting the risk requirements of the lender. The result of this analysis and simulation is a rule set that can achieve specific accuracy requirements and optimize the cost and use of Models. As expected, the performance using this rule set is significantly higher than with the industry standard approach.

### BRIEF DESCRIPTION OF THE DRAWINGS

FIG. 1 is a flow chart of the three-step process for optimizing AVM use.

FIG. 2 is a flow chart showing the sub-steps that make up the second step of FIG. 1.

FIG. 3 shows three tables exemplifying the ranking of combinations that have been deemed acceptable by the simulations.

### DETAILED DESCRIPTION OF THE INVENTION

### Using Multiple AVMs

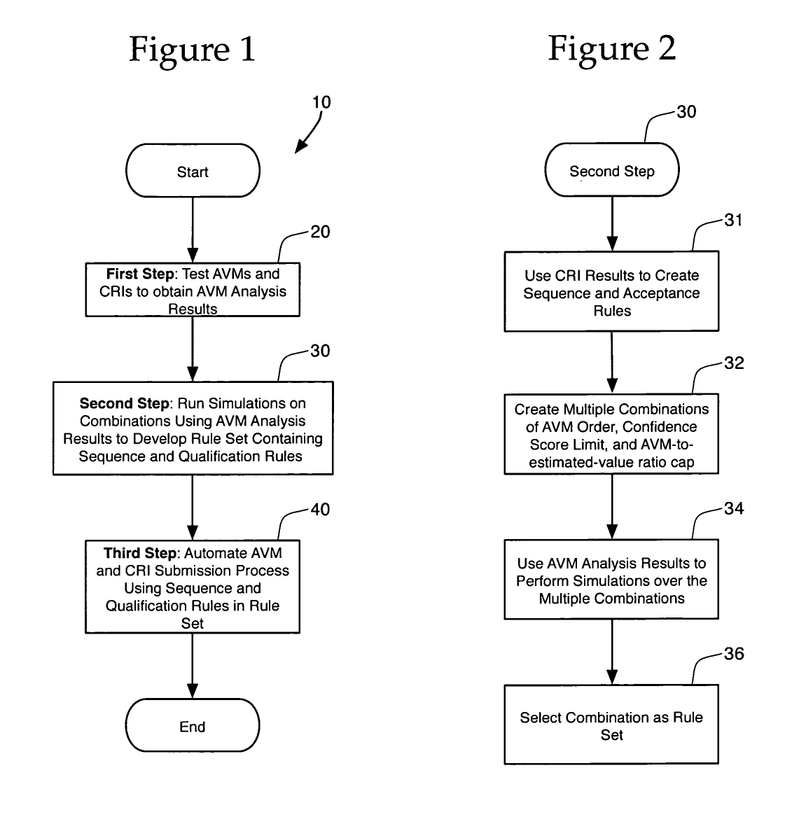

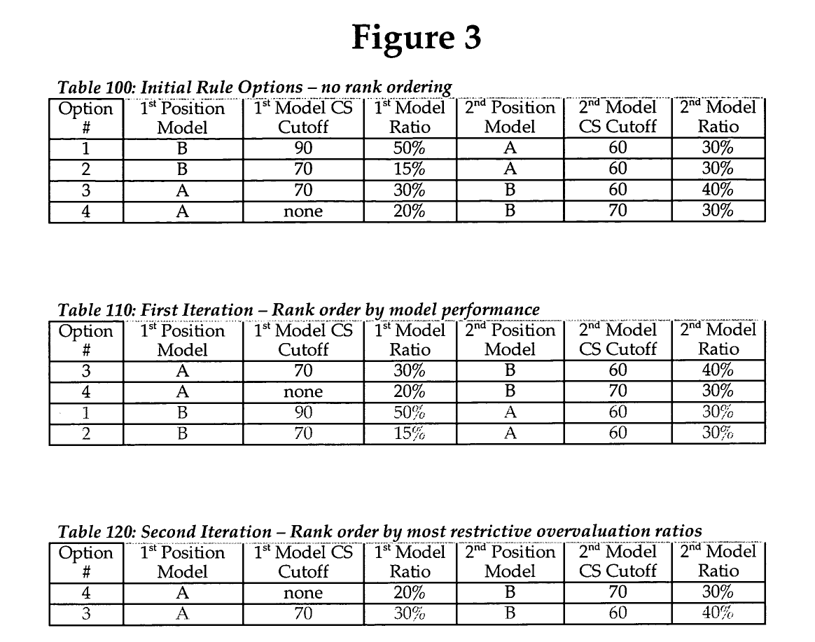

The key to optimizing a multiple-Model approach is to create rules governing the circumstances under which each Model should be requested and the result qualified. Therefore, a three-step process is required to optimize Model use, which is shown in FIG. 1. Each of these steps is computerized. The first step 20 is to test many Models in order to determine which are best for the institution's needs. The first step 20 is performed using application software running a computer that may range from a microcomputer to a mini or mainframe computer. The second step 30 is to use Model and CRI test results to determine rules governing the subset of potential Models and CRIs that will be called for a response in each circumstance, and the criteria that must be satisfied in order for a response from at least one Model to be qualified. The third step 40 is to create a computerized system to call Models according to the established rules. The first step 20 and third step 40 are well documented and accomplished based on established industry practices. Our invention relates to the second step 30. Each of the steps is discussed in detail below.

First Step 20—Test Models. Doing accurate AVM research is relatively difficult. However, help is available. This first step 20 is discussed in detail in the book “Automated Valuation Model Testing 101” by James Kirchmeyer and in many industry white papers. Some AVM providers are performing this type of research on behalf of clients who lack either the knowledge or capacity to complete the testing themselves. In addition, an industry consortium is developing a set of standards for AVM research. We generate AVM analysis by comparing multiple properties having a known real-world value against the values returned by the AVMs. We generate CRI analysis by creating data sets with true and simulated overvalued real properties. We compare the CRI results in the true vs. overvalued properties. The current invention embodiment is based on over 4,000,000 test records of Model results.

Second Step 30—Translate Model research into a rule set. Each institution wishing to use multiple Models must perform this step 30. The prior art practice is to use rudimentary overall performance rankings. For example, the prior art method for establishing the rules for properties located in California is to request a result first from the AVM that was most accurate in California. If that AVM could not produce a result, the system would request a value from the AVM that was the second-most accurate in California. The prior art method for CRI incorporates one product with a consistent score cutoff for all geographies. With this approach to AVMs and CRIs, prior art systems are doing the equivalent of establishing a baseball team's batting order by ranking players in order of their batting average, so that the player with the highest average bats first. This method is acceptable and produces a better result than random ranking, but it is not optimal.

Third Step 40—Obtain Model results in response to request for valuation. This is where testing meets production. The third step requires users to input rules into a computer system such that requests for valuations are processed based on the user's rule set. These rule sets are often referred to in the industry as “Cascades” because they allow users to cascade from one Model to another. The third step 40 was reduced to practice as early as 1997 by CoreLogic (at the time known as C&S Marketing). An industry publication from April 2005 listed nine providers of Cascades, including First American, TransUnion, FiServ, Countrywide and Veros Software.

### Translating AVM Research into Sequence and Qualification Rules

The present invention uses Model research to develop rule sets that are more sophisticated than the simplistic “most accurate first” rules established by the prior art systems. Using the baseball analogy, the present invention technique would be the equivalent of the baseball manager continuously re-establishing batting order based on batting average against a specific pitcher, in a specific stadium, under specific weather conditions, and considering the current number of outs and runners on each base.

This translation is accomplished in a computerized system in which a central processor unit operates an analysis application to define a rule set. The computerized rule set is then used in a Cascade program that determines how and whether loan data will be submitted to one or more Models. The Cascade program is a standard computer program that can operate on a microprocessor, minicomputer, or mainframe computer.

### The Goal: Rule Sets

The present invention improves on the results achieved by prior art by improving on the rule generation step 30 in order to create a better rule set for use by the Cascade program in step 40. A rule set is a set of individual rules, with the rules defining the logic by which the computerized system will submit properties to the various Models, and qualify or reject the Model responses returned by the Model provider. In the preferred embodiment, a rule is assigned to a geographic region in which a property might be submitted as well as to a price tier. For example, there could be separate rules for homes priced between $400,000 and $599,999 in Orange County (CA), homes priced between $600,000 and $799,999 in Orange County (CA), and homes priced between $600,000 and $799,999 in Los Angeles County (CA). When an institution requires a property value, the rules are consulted for the subject property being evaluated. Based on the location and price tier of the subject property, the rule for the appropriate geography and price tier is used to obtain Model results. As with all models, it is necessary to have a statistically significant number of observations in order to generate a rule that will produce consistent results over time. To return to the baseball analogy, knowing that a batter produced two hundred hits out of six hundred at-bats yields a much more reliable prediction of future hits than knowing a batter produced one hit out of three at-bats (even though the batting average would be the same number.) In some counties and price tiers within the United States, there are too few Model results to meet the threshold for significance. In those cases, the invention will either combine data from multiple counties, or determine that no combination will result in rules acceptable to the lender based on the lender's risk requirements. In the latter case, the area is considered a “no AVM zone” and the rule will state that no AVMs are to be qualified for properties in that area. Alternately, the CRI response may indicate that an AVM is not a suitable valuation source for a specific property. While the entire region is not restricted in this case, this particular property becomes part of the “no AVM zone” and no AVM result will be qualified for that property.

There are two aspects to each rule in a rule set.classifications The first aspect is a sequence rule, which contains the proper sequence for Model requests for that geography/price tier (i.e., first submit to CRI “1”, then submit to AVM “A”, then submit to AVM “B”). The second aspect is a qualification rule, which contains logic defining CRI cutoffs, confidence score cutoffs, and AVM-to-estimated value ratio. An individual rule in a rule set, as defined by a sequence component and a qualification component, can produce three types of outcomes: (1) no AVM response, (2) non-qualified AVM response, and (3) qualified AVM response. The no AVM response result means that either the property was located in a no AVM zone, or no AVM called was able to return a result. The non-qualified AVM response means that an AVM returned a response, but that response did not meet the thresholds established in the qualification portion of the rule. The qualified AVM response means that an AVM response was returned and met the all thresholds established in qualification rules. Note that CRI results can either be included in sequence rules (in which case they may alert the Cascade not to call AVMs) or in qualification rules (in which case they alert the Cascade to disqualify the AVM result returned.) The current preferred embodiment has 344 independent rule sets, where a rule set is defined by a geographic area, a price tier, a sequence rule, and associated qualification rules. There are also hundreds of no AVM zones, where the “rule” is to not request any Model results.

### Simulations

To improve the rule generation step, the present invention starts with the Model analysis results obtained in the first step 20 of overall process 10. The CRI test results are evaluated independently. We use CRI analysis to establish CRI sequence and acceptance rules. The CRI analysis is shown in FIG. 2 as sub-step 31 of the second step 30. The CRI order is either a listing of available CRIs in sequenced order, or a score cutoff for a specific CRI in a specific geography and price tier.

Next, we evaluate the AVM analysis. These tests give us the result for each AVM for a particular geographic area, but do not provide any guidance as to the sequence rules that should be used to select the order in which the AVMs should be used for a property. Order is very important because the Model results are not independent. If the first AVM in the sequence produces a “no hit,” the property may be in an area with poor data. The second AVM in the sequence is at a disadvantage because that AVM is only valuing the properties too difficult for the first AVM to value. Therefore, we must understand not only the second AVMs overall performance in a geography and price tier, but also how the second AVM performs on properties that the first AVM is unable to value. To accomplish this, the present invention uses a program to simulate, within various geographic areas at multiple price tiers, possible combination of three factors:
1) AVM order,
2) confidence score limit, and
3) AVM-to-estimated value ratio.
   The AVM analysis is shown in FIG. 2 as sub-step 32 of the second step 30. The AVM order is simply a listing of the available AVMs in a sequenced order. If there are three AVMs available to provide a valuation for a particular property, these AVMs could be referred to as AVM “A”, “B”, and “C”. There would be sixteen possible AVM orders: no AVM, A only, B only, C only, AB, AC, BA, BC, CA, CB, ABC, ACB, BAC, BCA, CAB, and CBA. If only two AVMs are available, there are only five possible AVM orders: no AVM, A only, B only, AB, and BA.

A confidence score is a score that each AVM gives to the valuation that it returns to a property to indicate how confident the AVM is in the returned valuation. Each vendor may have a different scale to indicate its confidence (such as a 10 to 1 ranking, a 100 to 1 ranking, or and “A” to “D” ranking.) For the purpose of this description, we have assumed a 100 to 1 ranking system, with a ranking of 100 being of the highest confidence. A confidence score limit is the minimum confidence score a lender will require in order to qualify a valuation.

An AVM-to-estimated value ratio is the ratio of the returned AVM valuation compared with the estimated value provided by the property owner. Valuations that are significantly higher or lower than the owner estimate indicate a potential valuation problem, and therefore this ratio is used to establish cutoff ratios. A negative cutoff ratio of X% represents disqualification of the AVM based on a valuation result that is X% lower than the owner's estimate. Conversely, a positive cutoff ratio of Y% represents disqualification of the AVM based on a valuation result that is Y% higher than the owner's estimate. Rules may have different negative and positive ratios.

Using AVM test results from the first step 20, the present invention performs simulations over various combinations of AVM orders, confidence score cutoffs, and AVM-to-value ratios. This is shown in FIG. 2 as sub-step 34. For each geographic area and price tier, we run these simulations on a statistical analysis platform such as the SAS platform (SAS Institute Inc., Cary, N.C.). The goal is to develop a rule set for that geography and price tier that can achieve specific accuracy requirements and optimize the cost and effectiveness of using the AVMs. The system would be overwhelmed if we tested every possible combination of AVM-to-value ratios (from −100% to infinity) and every possible confidence score cutoff (from 0 to 100) for three models across 15,000 area/price tier combinations. During the AVM analysis in first step 20, the confidence scores of each model are tested at distinct points to determine the cutoffs most likely to afford optimal risk management. For example, we may find that AVM “A” shows dramatic accuracy drops at confidence scores of 92, 84, 77, 61, and 50. For each model, up to five confidence score cutoffs are simulated. Similarly, up to five positive and five negative AVM-to-value ratios are simulated. The simulation processes every combination of confidence scores and AVM-to-value ratios input by the analyst based on AVM test results.

Each combination is analyzed using those test results obtained from the first step 20 that the rule determines are qualified AVM results. For each county and price tier, we then evaluate the hit rate and the accuracy of qualified AVM results for that combination over the sample data. Hit rate could be defined as obtaining a valuation, or could be more narrowly defined as a qualified hit rate meaning the percentage of properties where a valuation is returned that passes the relevant qualification rules. The accuracy of the combination's valuation could be evaluated using average standard deviation of the results, or through other relevant comparative statistics (such as the percentage of valuations that are within ten percent of the accepted value, or the percentage of valuations that are over the accepted value).

The desire is to obtain a rule set that satisfies certain minimum risk tenets established by the institution and produces the best qualified hit rate. Risk tenets, meaning the accuracy requirements for valuation results established by an institution, are defined relative to the accuracy of competing valuation services like full appraisals or broker price opinions. For example, we may determine that we will require AVM accuracy equal or exceed the accuracy historically achieved by full appraisals.

### Ranking Rule Sets

For a given geographic location and price tier, it is possible for there to be several combinations that meet the minimum risk tenets and produce statistically equivalent qualified hit rates. Because the present invention uses a single rule set for each property submission, a single rule must be selected from among the possible combinations (sub-step 36 in FIG. 2) for each geography and price tier. In the preferred embodiment, the highest ranked rule set will be selected using the following criteria:
1) Sequence rules where the AVM order best reflects the order of accuracy for the AVMs when analyzed alone;
2) Qualification rules with most restrictive positive AVM-to-value ratio cutoffs.
3) Qualification rules with the fewest restrictions on confidence scores.

Once the rules are established, the present invention follows accepted model validation practice and completes a validation test. It is in this step that the CRI rules and the AVM rules are combined. The validation test is comprised of Model results obtained on a separate data set than the results represented in first step 20. The rule set established by the invention is tested on the Model results obtained for the validation test. The rules determine which AVM results are qualified AVMs. The accuracy of the qualified AVMs are compared against the risk tenets. If the accuracy of the qualified AVMs is equal to or better than the established risk tenets, the rules are deemed to be validated and they are integrated into the Cascade system. If the accuracy of the qualified AVMs is worse than the risk tenet, the process begins again with a new test of AVMs. Production impact is calculated by looking at the percent of all transactions in each loan category that received a qualified AVM.

### RANKING EXAMPLE

The present invention can be seen in operation with an example that uses only two AVMs (A and B) and one CRI (1). Assume that the following four rule sets deliver similar (and acceptable) risk and hit rates. Further assume that, for the particular county and price tier under consideration, Model A tested superior to Model B. See Table 100 on FIG. 2.

The program first established a cutoff for CRI 1 for this geography and price tier. The cutoff in this example is “>60,” meaning that any CRI response greater than 60 will pass and allow the AVM call to proceed. The CRI cutoff is consistent, regardless of the final AVM order and therefore does not need to be represented in the Table 100 of FIG. 2.

The program then rank-orders the AVM options, giving better ranking to those options that place the most accurate model (in this case Model A) in the first position slot. See results of the first round of rank in Table 110 on FIG. 2.

The options with Model B in first position are dropped from consideration. The second iteration rank orders the remaining options based on the restrictiveness of overvaluation caps. See results of the second round of rank-ordering in Table 120 on FIG. 2.

In this case, a third iteration is not required. We select the sequence and AVM-related qualification rules in Option 4 as our final choice for the county and price tier. In addition to model position, confidence cutoffs and AVM-to-value ratio caps, rules for natural disaster suppression are independently established and added to the program as such events occur.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A computerized method for the creation of rules governing the source and qualification of property valuations from a plurality of automated valuation models (AVMs) and collateral risk indicators (CRIs) comprising:
a) testing the CRIs against known overvaluation results in order to generate CRI analysis results;
b) testing the AVMs against known property values in order to generate AVM analysis results;
c) generating rule sets based upon the AVM and CRI analysis results by performing the following steps in at least one computer system:
i) creating multiple combinations of data sets, the combinations each containing a different combination of CRI order, CRI score limit, AVM order, confidence score limit, and AVM-to-estimated value ratio cap, wherein the CRI order is a listing of available CRIs in a sequenced order, CRI score is an estimate of overvaluation risk, AVM order is a listing of available AVMs in a sequenced order, confidence score is an estimate of confidence in the valuation returned by the AVM, and AVM-to-estimated value ratio is the ratio of returned AVM valuation compared to the estimated value provided by a property owner;
ii) using the AVM analysis results for performing simulations over the various multiple combinations; and
iii) using results from the simulations for selecting a combination as a rule set where the combination meets a minimum risk tenet and produces a qualified hit rate; and
iv) using the rule set to submit properties to the plurality of CRIs and AVMs and to evaluate the valuations returned.

2. The method of claim 1, wherein multiple rule sets are created, with each rule set being assigned to a specific geographic area.

3. The method of claim 1, wherein multiple rule sets are created, with each rule set being assigned to a property price tier.

4. The method of claim 1, wherein multiple rule sets are created, with each rule set being assigned to a property price tier for a specific geographic area.

5. A computerized method for submitting loan data to a plurality of automated valuation model (AVMs) comprising:
a) testing the AVMs against known property values in order to generate AVM analysis results;
b) generating rule sets based upon the AVM analysis results by performing the following steps in at least one computer system:
i) creating multiple combinations of data sets, the combinations each containing a different combination of AVM order, confidence score limit, and AVM-to-estimated value ratio cap, wherein the AVM order is a listing of available AVMs in a sequenced order, confidence score is a valuation of confidence returned by the AVM, and AVM-to-estimated value ratio is the ratio of returned AVM valuation over the estimated value provided by a property owner,
ii) using the AVM analysis results for performing simulations over the various multiple combinations, and
iii) using results from the simulations for selecting a combination as a rule set where the combination meets a minimum risk tenet and produces a qualified hit rate; and
c) using the rule set to submit loan data to the plurality of AVMs and to evaluate the returned results.
